(19) United States
(12) Patent Application Publication
(10) Pub. No.: US 2016/0115304 A1
(43) Pub. Date: Apr. 28, 2016

(54) RECYCLED RUBBER PRODUCT AND METHODS

(71) Applicant: GREEN SOURCE HOLDINGS LLC, Austin, TX (US)

(72) Inventors: Shahram Reza SHAFIE, Austin, TX (US); Gregory Cobb MERRILL, Austin, TX (US)

(73) Assignee: GREEN SOURCE HOLDINGS LLC, Austin, TX (US)

(21) Appl. No.: 14/759,006

(22) PCT Filed: Jun. 29, 2015
(86) PCT No.: PCT/US2015/038310

§ 371 Date: Jul. 2, 2015

Related U.S. Application Data
(60) Provisional application No. 62/020,023, filed on Jul. 2, 2014.

(51) Int. Cl. C08L 9/06; C08L 7/00; C08L 9/02; C08L 9/00

(52) U.S. Cl. CPC C08L 9/06; C08L 9/00; C08L 7/00; C08L 9/02

(57) ABSTRACT

Devulcanized rubber products having uniform structural properties similar to that of virgin rubber and final vulcanized recycled rubber products having properties similar to vulcanized rubber products made using solely virgin rubber as the rubber input.

### FIELD OF THE INVENTION

The present disclosure relates generally to a recycled rubber product and processes and material for manufacturing the recycled rubber product.

### BACKGROUND OF THE INVENTION

The recycling of used or discarded vulcanized rubber products, including but not limited to tires, footwear, production waste, industrial parts, and other rubber products by devulcanization has proven to be an extremely challenging problem. This problem can be attributed to the fact that vulcanization cross-links polymers in the rubber or elastomer with sulfur. The resultant cross-linked rubber or elastomer is thermoset, thus preventing it from being melted or reformed into other products like thermoplastic polymers or metals. Key challenges of using recycled materials include ensuring a consistent feedstock of the raw chemicals into the new parts as well as incorporating them into existing rubber formulations, with no loss in performance.

An increasingly dire need exists to recover and devulcanize used or discarded tires and other rubber products, and to recycle them in a way that safely, economically and predictably results in a recycled rubber product having a uniform microstructure and structural properties similar to that of vulcanized rubber products made using solely virgin rubber as the rubber input.

The present invention includes a recycled rubber product having desirable structural properties similar to those products made using solely virgin rubber. The present invention includes a commercially viable recycled rubber for use in making high quality, high performance, durable, consumer rubber products and industrial parts and goods in the same or similar processes that are used for making vulcanized rubber products using virgin rubber.

The present invention includes a recycled rubber compound that reconstitutes vulcanized rubber having structural properties sufficiently similar to virgin rubber to be useful in rubber product manufacturing processes. While other existing methods have mixed recycled rubber with large amounts of virgin rubber to avoid the deficiencies of poor quality recycled rubber polymers or elastomers, such mixing reduces the energetic, environmental and commercial advantages of using recycled rubber rather than virgin rubber.

A method for devulcanizing rubber is disclosed in U.S. Pat. No. 7,767,722 to Fan et al., which is incorporated herein by reference in its entirety. The inventors have found that depending on the type of rubber selected for recycling, the conditions used for devulcanizing, the conditions used for processing the devulcanized rubber, and the conditions used for vulcanizing the devulcanized rubber, recycled rubber products having various different properties can be obtained. In particular, the invention described herein relates to a recycled rubber product and processes for manufacturing the recycled rubber product, wherein the devulcanized rubber product has uniform structural properties similar to that of virgin rubber and the vulcanized recycled rubber product has properties similar to vulcanized rubber products made using solely virgin rubber as the rubber input.

### SUMMARY OF INVENTION

An aspect of the present invention provides a devulcanized rubber product that has uniform structural properties similar to that of virgin rubber. Another aspect of the invention provides a process for safely, economically and predictably making a devulcanized rubber product that has uniform structural properties similar to that of virgin rubber.

Another aspect of the present invention provides a recycled vulcanized rubber product that has structural characteristics similar to those of vulcanized rubber products made using virgin rubber as the sole rubber input material. Another aspect of the invention provides a process for making a recycled vulcanized rubber product that has structural properties similar to those of vulcanized rubber products made using virgin rubber as the sole rubber input material in a predictable and environmentally and economically advantageous process.

According to an aspect of the invention, the recycled rubber product is a precursor material for making a final vulcanized recycled rubber product. Said precursor material is made by using a turpentine liquid as a devulcanizing agent to process vulcanized rubber containing sulfur cross-links.

The turpentine liquid is any one or more liquids selected from the group consisting of: natural turpentine, synthetic turpentine, pine oil, d-limonene, α-pinene, β-pinene, α-terpineol, β-terpineol, γ-terpineol, 3-carene, anethole, dipentene (p-mentha-1,8-diene), terpene resins, nopol, pinane, camphene, p-cymene, anisaldehyde, 2-pinane hydroperoxide, 3,7-dimethyl-1,6-octadiene, isobornyl acetate, terpin hydrate, ocimene, 2-pinanol, dihydromyrcenol, isoborneol, α-terpineol, alloocimene, alloocimene alcohols, geraniol, 2-methoxy-2,6-dimethyl-7,8-epoxyoctane, camphor, p-menthan-8-ol, α-terpinyl acetate, citral, citronellol, 7-methoxydihydrocitronellal, 10-camphorsulphonic acid, p-menthene, p-menthan-8-yl acetate, citronellal, 7-hydroxydihydrocitronellal, menthol, menthone, polymers thereof, and mixtures thereof.

According to a preferred aspect of the invention, the turpentine liquid is any one or more liquids selected from the group consisting of α-pinene, β-pinene, α-terpineol, p-cymene, polymers thereof, and mixtures thereof.

According to an aspect of the invention, the vulcanized rubber may be provided in any size that facilitates contact with a turpentine liquid. The rubber may be provided as chunks, one or more pieces, or blocks, for example, large fragments or pieces of an automobile or truck tire, auto parts, shoe soles, industrial products, rubber production waste, etc. The rubber may comprise an intact device or article such as an intact tire or sheet. According to a preferred aspect of the invention, the vulcanized rubber is provided as a vulcanized rubber crumb. According to a preferred aspect of the invention, the rubber crumb has an average particle size of from about 0.074 millimeters to about 50 millimeters.

According to an aspect of the invention, the rubber and the turpentine liquid are contacted at a temperature of from about 80° C. to about 180° C. Preferably, the rubber is contacted by the turpentine liquid at a temperature of from about 140° C. to about 170° C. More preferably, the rubber is contacted by the turpentine liquid at a temperature of about 160° C. According to the invention, the rubber is not dissolved in the turpentine liquid. Moreover, according to the invention, breakage of the sulfur cross-links of the vulcanized rubber is effected through chemical interaction of the turpentine liquid with the sulfur of the vulcanized rubber and not substantially through mechanical means or by action of high heat or high pressure.

According to an aspect of the invention, before vulcanization of the devulcanized rubber, the turpentine liquid trapped within the devulcanized rubber is extracted using an alcohol, an organic compound with a hydroxyl functional group, and/or one or more common solvents such as an organic or inorganic solvent, by contacting the turpentine-treated rubber material with the alcohol, or a mixture of the alcohol with an organic compound with one or more hydroxyl functional group(s) and/or an organic or inorganic solvent, such that a recovery mixture is formed, as well as residual material.

Still other aspects and advantages of the present invention will become readily apparent by those skilled in the art from the following detailed description, wherein it is shown and described preferred embodiments of the invention, simply by way of illustration of the best mode contemplated of carrying out the invention. As will be realized the invention is capable of other and different embodiments, and its several details are capable of modifications in various obvious respects, without departing from the invention. Accordingly, the description is to be regarded as illustrative in nature and not as restrictive.

### DETAILED DESCRIPTION OF A PREFERRED EMBODIMENT

In one aspect, the invention includes a precursor material for making a final vulcanized recycled rubber product. In certain embodiments, the precursor material includes devulcanized recycled rubber. A suitable precursor material having particularly advantageous properties is known as APX™ and is manufactured by Austin Rubber Company, LLC (Austin, Tex.). In some embodiments devulcanized recycled rubber is rubber having less than about 20% (e.g., about 15%, about 10%, about 5%, or close to 0) cross-links remaining after devulcanization. Typically, persons of skill in the rubber industry use PHR (parts per hundred rubber), meaning parts of any non-rubber material per hundred parts of rubber. In some embodiments, the precursor material includes at least about 150 PHR devulcanized, recycled rubber. In certain embodiments, the precursor material has a tensile strength of about 1-10 MPa, e.g., about 1.5-8, about 2-6, about 3-5 or about 4 MPa. In certain embodiments, the precursor material has elongation at break of about 60-300%, about 70-200%, or about 80-140%. In certain embodiments, the precursor material has a 50% modulus of about 0.5 to 5 MPa, about 1 to 4 MPa or about 1.3 to 3 MPa. In certain embodiments, the precursor material has a 100% modulus of about 1-7 MPa, about 2-5 MPa or about 2.0-4.5 MPa. In certain embodiments, the precursor material has a Shore A hardness of about 40-80 or about 50-65.

Tensile strength is discussed herein in units of MPa or kg/cm². A person of ordinary skill in the art would understand that one can readily convert between these units and that 1 MPa converts to about 10.197 kg/cm².

In certain embodiments, a final vulcanized recycled rubber product according to the present invention may include blending polymer(s), devulcanized recycled rubber according to the claimed invention, filler(s), plasticizer(s), coupling agent(s), resin(s), activator(s), process aid(s), and polyalkylene compounds (e.g., PEG). The blend may be further processed to make a final vulcanized recycled rubber product using one or more of activator(s), accelerator(s), and curative agent(s), e.g., sulfur.

As used herein, the terms “rubber,” “polymer” and “elastomer” describes the individual rubber/polymer/elastomer component or components mixed into a rubber compound.

As used herein, the term “rubber compound” refers to the mixture of rubber with other ingredients, including but not limited to fillers, process aids, activators, antidegradants, accelerators, curing agents and other components. Once a rubber compound has been mixed (blended) it can be formed and vulcanized into various products.

Polymers may include, but are not limited to natural rubber (NR), synthetic rubber, polybutadiene rubber (PBR), nitrile rubber (NBR), and styrene-butadiene rubber (SBR). Fillers may include, but are not limited to carbon black and silicas. Coupling agents may include, but are not limited to silanes. Plasticizers may include, but are not limited to hydrocarbon oil, naphthenic oil, and lubrication oil. Resins may include, but are not limited to high styrene resins, phenolic resins, and acrylonitrile-butadiene-styrene (ABS) resins. Activators may include, but are not limited to stearic acid, palmitic acid, and lauric acid and zinc salts thereof. Process aids, also known as processing agents, may include, but are not limited to Struktol® WB222, which is a highly concentrated, water free blend of high-molecular weight, aliphatic, fatty acid esters and condensation products, waxes, including polyethylene wax.

Activators may include, but are not limited to zinc oxides and chelates, magnesium oxides and chelates, fatty acids and zinc salts thereof. Accelerators may include, but are not limited to aldehyde amines, e.g., Hexamethylene tetramine (hexamine) (HMT), Ethylidene aniline (EA), guanidines, e.g., Diphenyl guanidine (DPG), Triphenyl guanidine (TPG), Di-o-tolyl guanidine (DOTG), thiazoles, e.g., Mercaptobenz-thiazole (MBT), Dibenzthiazyl disulfide (MBTS), 2,4-Dinitrophenyl mercapto-benzthiazole (DMB), and salts thereof, sulfenamides, e.g., N-Cyclohexylbenz-thiazylsulfenamide (CBS), N-Oxydiethylbenz-thiazylsulfenamide (NOBS), N-t-Butylbenzthiazyl-sulfenamide (NS, NZ), and N,N′-Dicyclo-hexylbenzhiazyl-sulfenamide (DZ), dithiocarbamates, e.g., Piperidine pentamethylene dithiocarbamate (PPD), Zinc diethyl dithiocarbamate (ZDC, ZDEC), Sodium diethyl dithiocarbamate (SDC), and Zinc ethyl phenyl dithiocarbamate, thiuram sulfides, e.g., Tetramethyl thiuram disulfide (TMT, TMTD), Tetraethyl thiuram disulfide (TET, TETD), Tetramethyl thiuram monosulfide (TMTM), Dipentamethylene thiuram tetrasulfate (DPTS), and xanthates, e.g., Zinc isopropyl xanthate (ZIX), Sodium isopropyl xanthate (SIX), and Zinc butyl xanthate (ZBX).

In certain embodiments, the precursor material is a devulcanized, recycled rubber that is a sulfur-based rubber. The devulcanized, recycled rubber is not a peroxide-based rubber. In certain embodiments, the precursor material includes a devulcanized, recycled rubber having a particle size within the range of about 325 mesh to about 1 mesh. In certain embodiments, the precursor material includes less than about 1% particles >30 mesh measured according to ASTM D5644. In certain embodiments, the precursor material includes less than about 15% (by weight), e.g., less than 13%, 12%, 11% or 10% particles >40 mesh measured according to ASTM D5644.

In certain embodiments, the precursor material includes less than about 2%, e.g., less than about 1, 0.7, 0.5, or 0.3% moisture content measured according to ASTM D1509. In certain embodiments, the precursor material has less than about 1%, e.g., less than about 0.5, 0.4, 0.3, 0.2, or 0.1% metal content measured according to ASTM D5603. In certain embodiments, the precursor material includes less than about 0.5%, e.g., less than about 0.2, 0.1, 0.05, 0.03, 0.02, or 0.01% fiber content measured according to ASTM D5603.

In certain embodiments, the precursor material includes about 2-10% acetone extractables according to ASTM E1131-03 (TGA). In certain embodiments, the precursor material includes about 2-5% acetone extractables measured according to ASTM E1131-03 (TGA). In certain embodiments, the precursor material includes about 30-65%, about 40-55% or about 50% polymer rubber hydrocarbon (RHC) content measured according to ASTM E1131-03 (TGA).

In certain embodiments, the precursor material includes about 20-50% carbon black and/or silica content measured according to ASTM E1131-03 (TGA). In certain embodiments, the precursor material includes about 20-45% or about 25-40% organic ash content measured according to ASTM E1131-03 (TGA). Silica types may include, but are not limited to amorphous silica, fumed silica, mercapto-silane treated silica, each of which may be precipitated, or combinations thereof.

In certain embodiments, the precursor material has a specific gravity of about 1.05-1.3, e.g., about 1.10-1.15 or about 1.12, measured according to ASTM D1817. In certain embodiments, the precursor material has a bulk density of about 0.20 to about 0.33, e.g., about 0.24 to about 0.32, e.g., about 0.25 to about 0.31.

In certain embodiments, the precursor material includes a plasticizer selected from the group consisting of hydrocarbon oil, naphthenic oil, and lubrication oil. In certain embodiments, the precursor material includes natural rubber, polybutadiene rubber and styrene-butadiene rubber (SBR).

In certain embodiments, the polymer portion of the precursor material includes about 5-95%, e.g., 20%, natural rubber and about 5-95%, e.g., 80%, synthetic rubber, e.g., styrene-butadiene rubber.

In certain embodiments, the polymer portion of the precursor material includes about 5-95%, e.g., 90%, natural rubber and about 5-95%, e.g., 10%, synthetic rubber, e.g., styrene-butadiene rubber.

In certain embodiments, the polymer portion of the precursor material includes about 5-95%, e.g., 80%, natural rubber and about 5-95%, e.g., 20%, synthetic rubber, e.g., polybutadiene rubber.

In certain embodiments, the polymer portion of the precursor material includes about 5-95% natural rubber and about 5-95% synthetic rubber.

In certain embodiments, the invention is directed to a precursor material that consists essentially of recycled devulcanized rubber. As used herein, the term “consists essentially of” means that the polymer portion of the precursor material contains less than 10% vulcanized rubber or virgin rubber.

Unprocessed vulcanized crumb rubber was found to have a bulk density of 0.34 kg/liter, acetone extractables of between 8-22%, and moisture content of <1%. In comparison, when the crumb rubber sample was processed according to the present invention to form the inventive precursor material, the inventive precursor material had a bulk density reduction to 0.25 kg/liter, reduced acetone extractables between 2-5% and reduced moisture content of <0.5%.

In another aspect, the invention includes a method for making the precursor material. In certain aspects, the method includes contacting a vulcanized rubber having a sulfur content and sulfur cross-links with a devulcanizing agent in a reaction mixture at about 80° C. to about 170° C. for about 1 to about 100 minutes, e.g., 1, 5, 10, 15, 20, 25, 30, 35, 40, 45, 50, 55, 60, 65, 70, 75, 80, 85, 90, 95, or 100 minutes, the devulcanizing agent being a turpentine liquid. In certain aspects, the contacting occurs at a temperature of about 85° C. to about 165° C. for about 20 to about 80 minutes. In certain aspects, the contacting occurs at a temperature of about 90° C. to about 160° C. for about 20 to about 60 minutes. In certain aspects, the contacting occurs at a temperature of about 130° C. to about 170° C.

The turpentine liquids may be a blend including α-terpineol, β-terpineol, α-pinene, β-pinene, and/or p-cymene. In one embodiment, the multi-component turpentine liquid includes at least about 30% α-terpineol. In another embodiment, the blend of turpentine liquids includes about 30-70% α-terpineol, about 5-40% β-pinene, 5-50% α-pinene, and about 0-30% p-cymene. In another embodiment, the blend of turpentine liquids includes about 40-60% α-terpineol, about 10-20% α-pinene, about 10-40% β-pinene, and about 5-20% p-cymene. In an alternative embodiment, a blend of turpentine liquids includes about 45-55% α-terpineol, about 30-40% α-pinene, about 5-30% β-pinene, and about 10-30% p-cymene. In another embodiment, a blend of turpentine liquids includes about 50% α-terpineol, about 25% α-pinene, about 20% β-pinene, and about 5% p-cymene.

The turpentine liquids may be a blend including pine oil, α-terpineol, β-terpineol, α-pinene, β-pinene, and/or p-cymene. In one embodiment, the multi-component turpentine liquid includes at least about 30% pine oil. In another embodiment, the blend of turpentine liquids includes about 30-70% pine oil, about 30-70% α-terpineol, about 5-40% β-pinene, 5-50% α-pinene, and about 0-30% p-cymene. In another embodiment, the blend of turpentine liquids includes about 30-50% pine oil, about 40-60% α-terpineol, about 10-20% α-pinene, about 10-40% β-pinene, and about 5-20% p-cymene. In an alternative embodiment, a blend of turpentine liquids includes about 30-40% pine oil, about 45-55% α-terpineol, about 30-40% α-pinene, about 5-30% β-pinene, and about 10-30% p-cymene.

In certain embodiments, the method includes the step of providing an alcohol, an organic compound with a hydroxyl functional group, and/or one or more common solvents such as an organic or inorganic solvent, and contacting the turpentine-treated rubber material with the alcohol, or a mixture of the alcohol with an organic compound with one or more hydroxyl functional group(s) and/or an organic or inorganic solvent, such that a recovery mixture is formed, as well as residual material. The recovery mixture contains at least a portion of the turpentine liquid that was trapped within the devulcanized rubber and at least one of the alcohol, the organic compound with one or more hydroxyl functional group(s), and/or organic or inorganic solvent.

In one embodiment, the alcohol is one or more acyclic or cyclic alcohols. For example, the alcohol can be simple alcohols such as methanol (methyl alcohol), ethanol (ethyl alcohol), propanol (propyl alcohol), isopropanol, butanol, isobutanol, pentanol and its eight more isomers (1-Pentanol, 3-Methyl-1-butanol, 2-Methyl-1-butanol, 2,2-Dimethyl-1-propanol, 3-Pentanol, 2-Pentanol, 3-Methyl-2-butanol, 2-Methyl-2-butanol) and hexanol and its sixteen more isomers (1-Hexanol, 2-Hexanol, 3-Hexanol, 2-Methyl-1-pentanol, 3-Methyl-1-pentanol, 4-Methyl-1-pentanol, 2-Methyl-2-pentanol, 3-Methyl-2-pentanol, 4-Methyl-2-pentanol, 2-Methyl-3-pentanol, Tertiary 3-Methyl-3-pentanol, Primary 2,2-Dimethyl-1-butanol, 2,3-Dimethyl-1-butanol, 3,3-Dimethyl-1-butanol, 2,3-Dimethyl-2-butanol, 3,3-Dimethyl-2-butanol, 2-Ethyl-1-butanol), lower aliphatic alcohols, or a mixture thereof. In certain embodiments, the alcohol is methanol (methyl alcohol), ethanol (ethyl alcohol), propanol (propyl alcohol), isopropanol, butanol, isobutanol, pentanol, hexanol, or a mixture thereof.

As used herein, the term “lower aliphatic alcohols” refers to primary, secondary and tertiary monohydric and polyhydric alcohols of between 2 and 12 carbon atoms. As used herein, the term “alkanes” refers to straight chain and branched chain alkanes of between 5 and 22 carbon atoms. As used herein, the term “aromatics” refers to monocyclic, heterocyclic and polycyclic compounds. As used herein, the term “aliphatic amines” refers to primary, secondary and tertiary amines having alkyl substituents of between 1 and 15 carbon atoms.

In certain aspects, the reaction mixture comprises said turpentine liquid and said vulcanized rubber in a ratio of about 1:1 to about 20:1, about 2:1 to about 15:1, 3:1 to 10:1, 4:1 to 7:1, or 5:1. Unless otherwise noted herein, ratios are disclosed as weight ratios.

In another aspect, the invention includes a vulcanized rubber product made using the precursor material of the invention. In certain aspects, a vulcanized rubber product according to the invention has a tensile strength of about 80-150 kg/cm². In certain aspects, a vulcanized rubber product according to the invention has a specific gravity of 1.10-1.25 g/cm³ according to SATRA TM205. In certain aspects, a vulcanized rubber product according to the invention has Die T Tear strength of 13-20 kg/cm thickness according to SATRA TM218. In certain aspects, a vulcanized rubber product according to the invention has DIN abrasion resistance of 120-200 mm³ according to SATRA TM174. In certain aspects, a vulcanized rubber product according to the invention has oil resistance (trimethylpentane) of 1-20% according to SATRA TM63 (tested at room temperature for 24 hours). In certain aspects, a vulcanized rubber product according to the invention has oil resistance of about 0.5-5% according to FIA391 IRM #903 (tested at room temperature for 22 hours). In certain aspects, a vulcanized rubber product according to the invention has a 100% modulus of about 60-100 kg/cm². In certain aspects, a vulcanized rubber product according to the invention has a 300% modulus of about 15-25%. In certain aspects, a vulcanized rubber product according to the invention includes about 10%-80% by weight devulcanized, recycled rubber (before vulcanization of the rubber product).

In certain aspects, a vulcanized rubber product according to the invention includes a plasticizer selected from the group consisting of hydrocarbon oil, naphthenic oil, and lubrication oil.

In another aspect, the invention includes a vulcanized rubber product comprising a vulcanized mixture of 20 to 90% by weight virgin rubber and 10 to 80% by weight of a precursor material having, before vulcanization, a plurality of parameters selected from the group consisting of a tensile strength of about 1-10 MPa, elongation at break of about 60-300%, a 50% modulus of about 0.5 to 5 MPa, a 100% modulus of about 1-7 MPa, and Shore A hardness of about 40-80. In certain aspects, a vulcanized rubber product according to the invention contains a precursor material having, before vulcanization, a tensile strength of about 1.8-6.7 MPa. In certain aspects, a vulcanized rubber product according to the invention contains a precursor material having, before vulcanization, a elongation at break of about 80-140%. In certain aspects, a vulcanized rubber product according to the invention contains a precursor material having, before vulcanization, a 50% modulus of about 1.3 to 3 MPa. In certain aspects, a vulcanized rubber product according to the invention contains a precursor material having, before vulcanization, a 100% modulus of about 2.0-4.5 MPa. In certain aspects, a vulcanized rubber product according to the invention contains a precursor material having, before vulcanization, a Shore A hardness of about 50-65.

In another aspect, the invention includes a method for making a final vulcanized recycled rubber product, including the steps of obtaining a precursor material comprising a devulcanized, recycled rubber as described above, compounding the precursor material with virgin rubber to form a rubber compound mixture, and vulcanizing the rubber compound mixture to obtain said final vulcanized recycled rubber product.

In certain aspects, the method is adapted so as to obtain said final vulcanized recycled rubber product having a tensile strength of about 80-150 kg/cm². In certain aspects, the method is adapted so as to obtain said final vulcanized recycled rubber product having a specific gravity of 1.10-1.25 g/cm³ according to SATRA TM205. In certain aspects, the method is adapted so as to obtain said final vulcanized recycled rubber product having Die T Tear strength of 13-20 kg/cm thickness according to SATRA TM218. In certain aspects, the method is adapted so as to obtain said final vulcanized recycled rubber product having DIN abrasion resistance of 120-200 mm³ according to SATRA TM174.

In certain aspects, the method is adapted so as to obtain said final vulcanized recycled rubber product having oil resistance (trimethylpentane) of 1-20% according to SATRA TM63. In certain aspects, the method is adapted so as to obtain said final vulcanized recycled rubber product having oil resistance of about 0.5-5% according to FIA391 IRM #903. In certain aspects, the method is adapted so as to obtain said final vulcanized recycled rubber product having a 100% modulus of about 60-100 kg/cm². In certain aspects, the method is adapted so as to obtain said final vulcanized recycled rubber product having a 300% modulus of about 15-25%.

Devulcanization may be carried out by immersing cured (vulcanized) rubber or elastomer in one or more turpentine liquids in the form of a bed of particles or pieces of cured rubber or elastomer whose sizes are within the range of about 0.074 mm (200 mesh) to about 50 mm in a vessel (reactor) that contains one or more of the said devulcanization reagents.

The turpentine liquid penetrates or diffuses into the particles or pieces of cured (vulcanized) rubber or elastomer at an appreciable rate, thus causing the particles or pieces to swell and remain swelled appreciably and permanently. By utilizing any of the devulcanization reagents and processes of this invention, cured (vulcanized) rubber or elastomer can be devulcanized with a simple technique without the need for dissolving rubber, high-pressures vessels (reactors), microwaves, ultrasonic waves, catalysts or an additional reagent, such as alkali metal or carbon dioxide.

In certain embodiments, a vulcanized recycled rubber product may contain more than trace amounts of one of silica and carbon black, but not more than trace amounts of both silica and carbon black.

More specifically, the present invention relates to the materials, products and methods described below.

Item 1. A precursor material for making a final vulcanized recycled rubber product, said precursor material comprising devulcanized, recycled rubber, and having a plurality of parameters selected from the group consisting of a tensile strength of about 1-10 MPa, e.g., 2-6 MPa or 3-4 MPa, elongation at break of about 60-300%, e.g., 70-200% or 80-140%, a 50% modulus of about 0.5 to 5 MPa, e.g., 1 to 4 MPa or 1.3 to 3 MPa, a 100% modulus of about 1-7 MPa, e.g., 2-5 MPa or 2.5 to 4 MPa, and Shore A hardness of about 40-80, e.g., 50-65.

Item 2. The precursor material of item 1, wherein said devulcanized, recycled rubber is a sulfur-based rubber.

Item 3. The precursor material of items 1-2, wherein said devulcanized, recycled rubber is not a peroxide-based rubber.

Item 4. The precursor material of items 1-3, wherein said devulcanized, recycled rubber has a particle size within the range of about 325 mesh to about 1 mesh.

Item 5. The precursor material of items 1-4, comprising less than 2% or less than about 1%, or less than about 0.5% moisture content according to ASTM D1509.

Item 6. The precursor material of items 1-5, comprising less than about 1%, less than about 0.5%, or less than about 0.1% metal content according to ASTM D5603.

Item 7. The precursor material of items 1-5, comprising less than about 0.5%, less than about 0.1%, or less than about 0.01% fiber content according to ASTM D5603.

Item 8. The precursor material of items 1-6, comprising less than about 1% particles >30 mesh according to ASTM D5644.

Item 9. The precursor material of items 1-7, comprising less than about 11% particles >40 mesh according to ASTM D5644.

Item 10. The precursor material of items 1-8, comprising about 2-10% acetone extractables according to ASTM E1131-03 (TGA).

Item 11. The precursor material of items 1-9, comprising about 2-5% acetone extractables according to ASTM E1131-03 (TGA).

Item 12. The precursor material of items 1-10, comprising about 30-65% or about 40 to about 55%, or about 45% polymer rubber hydrocarbon (RHC) content according to ASTM E1131-03 (TGA).

Item 13. The precursor material of items 1-11, comprising about 20-50% or about 25 to 40% carbon black and/or silica content according to ASTM E1131-03 (TGA).

Item 14. The precursor material of items 1-12, comprising about 20-45% or about 25 to 40% organic ash content according to ASTM E1131-03 (TGA).

Item 15. The precursor material of items 1-13, having a specific gravity of about 1.05-1.3 or about 1.10-1.15 according to ASTM D1817.

Item 16. The precursor material of items 1-14, having a bulk density of about 0.20 to about 0.33 kg/liter.

Item 17. The precursor material of items 1-15, having a bulk density of about 0.24 to about 0.32 kg/liter.

Item 18. The precursor material of items 1-16, having a bulk density of about 0.25 to about 0.31 kg/liter.

Item 19. The precursor material of items 1-17, comprising a plasticizer selected from the group consisting of hydrocarbon oil, naphthenic oil, and lubrication oil.

Item 20. The precursor material of items 1-18, comprising natural rubber, polybutadiene rubber and styrene-butadiene rubber.

Item 21. The precursor material of items 1-20, comprising about 20% natural rubber and about 80% styrene-butadiene rubber.

Item 22. The precursor material of items 1-21, comprising about 90% natural rubber and about 10% styrene-butadiene rubber.

Item 23. The precursor material of items 1-22, comprising about 80% natural rubber and about 20% polybutadiene rubber.

Item 24. The precursor material of items 1-23, wherein said precursor material has at least three of said parameters.

Item 25. The precursor material of items 1-24, wherein said precursor material has at least four of said parameters.

Item 26. The precursor material of items 1-25, wherein said precursor material has all of said parameters.

Item 27. A vulcanized recycled rubber product comprising the precursor material of claims 1-26 as a majority portion.

Item 28. A vulcanized recycled rubber product having a plurality of parameters selected from the group consisting of a tensile strength of about 80-150 kg/cm², a specific gravity of 1.10-1.25 g/cm³ according to SATRA TM205, Die T Tear strength of 13-20 kg/cm thickness according to SATRA TM218, DIN abrasion resistance of 120-200 mm³ according to SATRA TM174, oil resistance (trimethylpentane) of 1-20% according to SATRA TM63, oil resistance of about 0.5-5% according to FIA391 IRM #903, a 100% modulus of about 60-100 kg/cm², and a 300% modulus of about 15-25%, and before vulcanization of said rubber product, about 10%-80% by weight devulcanized, recycled rubber.

Item 29. The vulcanized recycled rubber product of item 28, comprising a plasticizer selected from the group consisting of hydrocarbon oil, naphthenic oil, and lubrication oil.

Item 30. The vulcanized recycled rubber product of items 28-29, wherein said vulcanized recycled rubber product has at least three of said parameters.

Item 31. The vulcanized recycled rubber product of items 28-30, wherein said vulcanized recycled rubber product has at least four of said parameters.

Item 32. The vulcanized recycled rubber product of items 28-31, wherein said vulcanized recycled rubber product has all of said parameters.

Item 33. A vulcanized recycled rubber product comprising, as its polymer portion, a vulcanized mixture of 20 to 90% by weight virgin rubber and 10 to 80% by weight of a precursor material having, before vulcanization, a plurality of parameters selected from the group consisting of a tensile strength of about 1.8-6.7 MPa, elongation at break of about 80-140%, a 50% modulus of about 1.3 to 3 MPa, a 100% modulus of about 2.0-4.5 MPa, and Shore A hardness of about 50-65.

Item 34. The vulcanized recycled rubber product of item 33, having shore A hardness of at least about 56, tensile strength of about 88-148 kg/cm² and elongation of about 430-480%.

Item 35. The vulcanized recycled rubber product of items 33-34, having a plurality of parameters selected from the group consisting of a specific gravity of 1.10-1.25 g/cm³ according to SATRA TM205, Die T Tear strength of 13-20 kg/cm thickness according to SATRA TM218, DIN abrasion resistance of 120-200 mm³ according to SATRA TM174, oil resistance (trimethylpentane) of 1-20% according to SATRA TM63, oil resistance of about 0.5-5% according to FIA391 IRM #903, a 100% modulus of about 60-100 kg/cm², and a 300% modulus of about 15-25%.

Item 36. The vulcanized recycled rubber product of items 33-34, wherein said precursor material has at least three of said parameters.

Item 37. The vulcanized recycled rubber product of items 33-34, wherein said precursor material has at least four of said parameters.

Item 38. The vulcanized recycled rubber product of items 33-34, wherein said precursor material has all of said parameters.

Item 39. A method for making a devulcanized rubber material having a plurality of parameters selected from the group consisting of a tensile strength of about 1.8-6.7 MPa, elongation at break of about 80-140%, a 50% modulus of about 1.3 to 3 MPa, a 100% modulus of about 2.0-4.5 MPa, Shore A hardness of 50-65, comprising contacting a vulcanized rubber having a sulfur content and sulfur cross-links with a devulcanizing agent in a reaction mixture at about 80° C. to about 170° C. for about 10 to about 100 minutes, the devulcanizing agent being a turpentine liquid.

Item 40. The method of item 39, wherein said contacting occurs at a temperature of about 85° C. to about 165° C. for about 20 to about 80 minutes.

Item 41. The method of items 39-40, wherein said contacting occurs at a temperature of about 90° C. to about 160° C. for about 20 to about 60 minutes.

Item 42. The method of items 39-41, wherein said reaction mixture comprises said turpentine liquid and said vulcanized rubber in a ratio of about 2:1 to about 7:1.

Item 43. The method of items 39-42, wherein said reaction mixture comprises said turpentine liquid and said vulcanized rubber in a ratio of about 3:1 to about 5:1.

Item 44. The method of items 39-43, wherein said devulcanized rubber material has at least three of said parameters.

Item 45. The method of items 39-44, wherein said devulcanized rubber material has at least four of said parameters.

Item 46. The method of items 39-45, wherein said devulcanized rubber material has all of said parameters.

Item 47. A method for making a final vulcanized recycled rubber product, comprising obtaining a precursor material comprising about 10%-80% by weight of a devulcanized, recycled rubber, and having a plurality of parameters selected from the group consisting of a tensile strength of about 1.8-6.7 MPa, elongation at break of about 80-140%, a 50% modulus of about 1.3 to 3 MPa, a 100% modulus of about 2.0-4.5 MPa, Shore A hardness of 50-65 and comprising, compounding said precursor material with virgin rubber to form a mixture, and vulcanizing said mixture to obtain said final vulcanized recycled rubber product.

Item 48. The method of item 47, wherein said method is adapted so as to obtain said final vulcanized recycled rubber product having a tensile strength of about 80-150 kg/cm².

Item 49. The method of items 47-48, wherein said method is adapted so as to obtain said final vulcanized recycled rubber product having a specific gravity of 1.10-1.25 g/cm³ according to SATRA TM205.

Item 50. The method of items 47-49, wherein said method is adapted so as to obtain said final vulcanized recycled rubber product having Die T Tear strength of β-20 kg/cm thickness according to SATRA TM218.

Item 51. The method of items 47-50, wherein said method is adapted so as to obtain said final vulcanized recycled rubber product having DIN abrasion resistance of 120-200 mm³ according to SATRA TM174.

Item 52. The method of items 47-51, wherein said method is adapted so as to obtain said final vulcanized recycled rubber product having oil resistance (trimethylpentane) of 1-20% according to SATRA TM63.

Item 53. The method of items 47-52, wherein said method is adapted so as to obtain said final vulcanized recycled rubber product having oil resistance of about 0.5-5% according to FIA391 IRM #903.

Item 54. The method of items 47-53 wherein said method is adapted so as to obtain said final vulcanized recycled rubber product having a 100% modulus of about 60-100 kg/cm².

Item 55. The method of items 47-54, wherein said method is adapted so as to obtain said final vulcanized recycled rubber product having a 300% modulus of about 15-25%.

Item 56. The method of items 47-55, wherein said final vulcanized recycled rubber product has at least three of said parameters.

Item 57. The method of items 47-56, wherein said final vulcanized recycled rubber product has at least four of said parameters.

Item 58. The method of items 47-57, wherein said final vulcanized recycled rubber product has all of said parameters.

Item 59. A vulcanized recycled rubber product formulation comprising a virgin rubber, carbon black, zinc oxide, stearic acid, sulfur, and a precursor material comprising devulcanized, recycled rubber, wherein said vulcanized recycled rubber product does not contain silica.

Item 60. The vulcanized recycled rubber of item 59, further comprising a plurality of Dioctyl Terephthalate (DOTP), Octylated Diphenylamine (ODP), Coumarone Indene Resin, Benzothiazole Disulfide (MBTS), Benzothiazole-2-thiol (MBT), and Tetramethylthiuram Disulfide (TMTD).

Item 61. The vulcanized recycled rubber of items 59-60, having Shore A hardness of 60-65, specific gravity below 1.2 g/cm³, tensile strength >100 kg/cm², elongation strength >400%, die T tear strength >8 kg/cm, DIN abrasion resistance <150 mm³, oil resistance (trimethylpentane) <12%, and oil resistance (IRM #903) <10%.

### EXAMPLES

### Example 1

In this example, a comparison of Thermal Gravimetric Analysis (TGA) of unprocessed vulcanized tire tread rubber formulation (made using 100% virgin natural rubber and styrene-butadiene rubber) to the same vulcanized rubber sample that is then treated with a turpentine liquid blend of terpineol, pinene and cymene according to the present invention to obtain a precursor material is described.

TABLE 1

| | T | time | | Residual Turpentine | Highly Volatile | Polymer | Carbon Black | Ash | |
|---|---|---|---|---|---|---|---|---|---|
| Sample | (° C.) | (min) | Turpentine:Rubber | (%) | (%, 25-325° C.) | (%, 325-550° C.) | (%, 550-850° C.) | (%) | Total |
| Unprocessed | — | — | — | — | 15.01 | 49.71 | 32.09 | 3.19 | 100.0 |
| Processed | 90 | 20 | 5:1 | 0.25 | 4.31 | 52.82 | 36.07 | 2.00 | 100.0 |

### Example 2

In this example, a comparison of Thermal Gravimetric Analysis (TGA) of unprocessed vulcanized tire tread rubber formulation (made using 100% virgin natural rubber and styrene-butadiene rubber) (“CONTROL”), processed vulcanized tire tread rubber formulation (made using a mixture of 100% virgin natural rubber and styrene-butadiene rubber that has been processed according to the present invention) (“RECYCLE”), to processed vulcanized rubber samples having been made using 95% virgin natural rubber and styrene-butadiene rubber/5% devulcanized rubber using of the claimed invention (“Tread 5%”), 90% virgin natural rubber and styrene-butadiene rubber/10% devulcanized rubber using of the claimed invention (“Tread 10%”), 80% virgin natural rubber and styrene-butadiene rubber/20% devulcanized rubber using of the claimed invention (“Tread 20%”) each of which being processed by treatment with a turpentine liquid blend of terpineol, pinene and cymene according to the present invention to obtain a precursor material is described.

TABLE 2

| | T | time | | Highly Volatile | Polymer | Carbon Black | Ash | |
|---|---|---|---|---|---|---|---|---|
| Sample | (° C.) | (min) | Turpentine:Rubber | (%, 25-325° C.) | (%, 325-550° C.) | (%, 550-850° C.) | (%) | Total |
| CONTROL | — | — | — | 12.2 | 52.8 | 33.5 | 1.5 | 100.0 |
| RECYCLE | | | | 4.7 | 55.2 | 36.8 | 3.3 | 100.0 |
| Tread 5% | 90 | 20 | 5:1 | 12.2 | 52.4 | 33.8 | 1.6 | 100.0 |
| Tread 10% | 90 | 20 | 5:1 | 11.5 | 53.1 | 33.7 | 1.7 | 100.0 |
| Tread 20% | 90 | 20 | 5:1 | 10.3 | 53.6 | 34.2 | 1.9 | 100.0 |

### Example 3

In this example, a comparison of Thermal Gravimetric Analysis (TGA) of vulcanized post-consumer whole truck tire (WTT) samples or truck tire tread “buffings” before and after processing by treatment with a turpentine liquid blend of terpineol, pinene and cymene according to the present invention to obtain a precursor material is described.

TABLE 3

| | T | time | | Size | Highly Volatile | Polymer | Carbon Black | Ash |
|---|---|---|---|---|---|---|---|---|
| Sample | (° C.) | (min) | Turpentine:Rubber | (mesh) | (%, 25-325° C.) | (%, 325-550° C.) | (%, 550-850° C.) | (%) |
| WTT | — | — | — | 40 | 11.0 | 49.1 | 35.1 | 4.8 |
| Unprocessed | | | | | | | | |
| WTT | 90 | 20 | 5:1 | 40 | 4.6 | 51.7 | 38.9 | 4.9 |
| Processed | | | | | | | | |
| Buffings 1 | — | — | — | 40 | 10.9 | 47.5 | 36.6 | 4.9 |
| Unprocessed | | | | | | | | |
| Buffings 1 | 90 | 20 | 5:1 | 40 | 4.8 | 50.7 | 39.5 | 5.0 |
| Processed | | | | | | | | |
| Buffings 2 | — | — | — | 140 | 13.6 | 38.0 | 41.3 | 7.1 |
| Unprocessed | | | | | | | | |
| Buffings 2 | 90 | 20 | 5:1 | 140 | 12.2 | 34.7 | 45.8 | 7.3 |
| Processed | | | | | | | | |

### Example 4

In this example, a comparison of Thermal Gravimetric Analysis (TGA) of vulcanized post-consumer whole truck tire (WTT) samples before and after processing by treatment with a turpentine liquid blend of terpineol, pinene and cymene according to the present invention to obtain a precursor material is described.

TABLE 4

| | T | Processing time | Size | Highly Volatile | Polymer | Carbon Black | Ash |
|---|---|---|---|---|---|---|---|
| Sample | (° C.) | (min) | (mesh) | (%, 25-325° C.) | (%, 325-550° C.) | (%, 550-850° C.) | (%) |
| WTT | — | — | 40 | 13.1 | 41.9 | 38.6 | 6.4 |
| Unprocessed | | | | | | | |
| WTT | 160 | 20 | 40 | 2.9 | 53.1 | 37.0 | 7.0 |
| Processed | | | | | | | |
| WTT | 160 | 40 | 40 | 4.0 | 49.0 | 40.1 | 6.9 |
| processed | | | | | | | |

### Example 5

In this example, a comparison of Brunauer-Emmett-Teller (BET) analysis of vulcanized post-consumer whole truck tire (WTT) samples before and after processing by treatment with a turpentine liquid blend of terpineol, pinene and cymene according to the present invention to obtain a precursor material is described. The row of Table 5 labeled “Toluene 90/20” refers to an experiment in which the processing was performed using toluene instead of a turpentine liquid blend of terpineol, pinene and cymene for comparison. BET explains the physical adsorption of gas molecules on a solid surface and serves as the basis for an important analysis technique for the measurement of the specific surface area of a material. Increased BET values mean that the pores of the devulcanized rubber is permanently larger after processing compared to crumb rubber.

TABLE 5

| | | | | Multi-Point | Single-Point | |
|---|---|---|---|---|---|---|
| Processing | | | Crumb | BET Surface | BET Surface | |
| Parameters | Mixing Time | Crumb | size | Area | Area | |
| ° C. | (min) | type | (mesh) | m²/g | m²/g | @P/P₀ |
| Unprocessed | — | WHTT | 40 | 0.158 | 0.0982 | 0.30009 |
| 90 | 20 | WHTT | 40 | 0.188 | 0.1363 | 0.29764 |
| 120 | 60 | WHTT | 40 | 0.214 | 0.1540 | 0.30443 |
| Unprocessed | — | WHTT | 40 | 0.171 | 0.1199 | 0.3102 |
| 90 | 20 | WHTT | 40 | 0.186 | 0.1410 | 0.3095 |
| 120 | 60 | WHTT | 40 | 0.236 | 0.1732 | 0.2963 |
| Unprocessed | — | WHTT | 40 | 0.073 | 0.0574 | 0.3037 |
| 90 | 20 | WHTT | 40 | 0.194 | 0.1489 | 0.3011 |
| 120 | 60 | WHTT | 40 | 0.178 | 0.1348 | 0.3147 |
| Unprocessed | — | WHTT | 140 | 1.261 | 0.9500 | 0.2954 |
| 90 | 20 | WHTT | 140 | 1.809 | 1.4187 | 0.2907 |
| 120 | 60 | WHTT | 140 | 1.487 | 1.1758 | 0.2871 |

### Example 6

In this example, a comparison of bed height expansion of vulcanized post-consumer crumb rubber samples before and after processing by treatment with various turpentine liquids according to the present invention, including washing with alcohol to remove the turpentine liquids, to obtain a precursor material is described. As another control, the unprocessed crumb rubber was treated with isopropyl alcohol to determine whether or not non-turpentine liquids cause permanent bed height expansion. Table 6 is a representative set of data.

TABLE 6

| | Contact | | Mean Bed | % |
|---|---|---|---|---|
| | Temp., | Contact | Height | Volume |
| Sample | ° C. | time, min | (mm) | Expansion |
| Crumb Rubber | — | — | 110.0 | 0 |
| (Unprocessed) | | | | |
| Isopropyl Alcohol | 25 | 120 | 117.0 | 6 |
| Treatment Control | | | | |
| alpha-Terpineol | 90 | 20 | 132.0 | 20 |
| p-Cymene | 90 | 20 | 137.3 | 25 |
| alpha-Pinene | 90 | 20 | 141.3 | 28 |
| beta-Pinene | 90 | 20 | 137.3 | 25 |
| alpha-Terpineol | 120 | 60 | 147.3 | 34 |
| p-Cymene | 120 | 60 | 143.3 | 30 |
| alpha-Pinene | 120 | 60 | 157.3 | 43 |
| beta-Pinene | 120 | 60 | 144.0 | 31 |
| Blend of terpineol, | 90 | 20 | 125.7 | 14 |
| pinene and cymene | | | | |
| Blend of terpineol, | 120 | 60 | 138.7 | 26 |
| pinene and cymene | | | | |

### Example 7

In this example, a comparison of product structural characteristics before and after processing by treatment with a blend of turpentine liquids according to the present invention, including washing with alcohol to remove the turpentine liquid blend, to obtain a precursor material is described. Table 7 is a representative set of data.

TABLE 7

| | | Tensile | Elongation | Modulus | |
|---|---|---|---|---|---|
| | Contact | Strength | at Break | at 50% | Modulus at 100% |
| Sample | Temp., ° C. | (MPa) | (%) | (MPa) | (MPa) |
| Crumb Rubber | — | 1.8 ± 0.1 | 108.4 ± 8.9 | 1.15 ± 0.02 | 1.75 ± 0.03 |
| (Unprocessed) | | | | | |
| 1 | 90 | 2.8 ± 0.2 | 109.3 ± 6.2 | 1.71 ± 0.03 | 2.71 ± 0.1 |
| 2 | 90 | 3.0 ± 0.1 | 115.6 ± 5.2 | 1.72 ± 0.03 | 2.81 ± 0.06 |
| 3 | 160 | 3.2 ± 0.1 | 134.3 ± 4.4 | 1.73 ± 0.01 | 2.77 ± 0.03 |
| 4 | 160 | 3.5 ± 0.2 | 140.5 ± 9.4 | 1.73 ± 0.02 | 2.83 ± 0.03 |
| 5 | 160 | 3.6 ± 0.1 | 152.5 ± 6.7 | 1.62 ± 0.02 | 2.65 ± 0.03 |

From repeated experiments (420 sets of data), the following ranges of characteristics for the unprocessed and processed products were determined:

| | Tensile | | Modulus | Elongation |
|---|---|---|---|---|
| | Strength | Modulus at | at 100% | at Break |
| Sample | (MPa) | 50% (MPa) | (MPa) | (%) |
| Unprocessed | 0.18-1.43 | 0.95-1.11 | 1.22-1.59 | 15.2-100.7 |
| Processed | 1.8-6.7 | 1.38-2.88 | 2.10-4.44 | 80-139.8 |

### Example 8

In this example, several precursor material samples made using various devulcanized rubber were incorporated into a formulation for making a final vulcanized recycled rubber product. The precursor material formulations contained the following ranges of components:

TABLE 8

| Ingredient Class | PHR | % BY WT |
|---|---|---|
| POLYMER BLEND | 40-130 | 25-60 |
| RECYCLED DEVULCANIZED RUBBER | 8-85 | 5-50 |
| FILLER | 20-50 | 10-30 |
| PLASTICIZER | 4-10 | 2-5 |
| COUPLING AGENT | 2-4 | 1-2 |
| HIGH STYRENE RESIN | 4-6 | 2-3 |
| ACTIVATOR | 1-2 | 0.5-1 |
| PEG | 1-2 | 0.6-1 |
| PROCESS AIDS | 1-3 | 0.5-2 |

To the formulations summarized in Table 8, activator (about 1-4 PHR), accelerators (1-2 PHR), and sulfur (about 0.3-1.5 PHR) were added and cured to obtain a a final vulcanized recycled rubber product. The final vulcanized recycled rubber product was tested according to various standard testing procedures and the final vulcanized recycled rubber product of the present invention has the following parameters:

TABLE 9

| Spec | | | Range | |
|---|---|---|---|---|
| Ref | Test Name | Units | Lower limit | Upper limit |
| ASTM | ML | lbf · in | 25.00 | 33.00 |
| D2084 | MH | lbf · in | 43.00 | 59.00 |
| | CRI | 90/1 | 9.00 | 39.00 |
| | Tc90 | min | 4.00 | 14.00 |
| | Tc95 | min | 5.00 | 17.00 |
| | Ts1 | min | 1.00 | 4.00 |
| | Ts2 | min | 1.00 | 4.00 |
| ASTM | Mooney Viscosity | ML1 + 4 | 144.00 | 180.00 |
| D1646 | | | | |
| ASTM | Zwick Rebound | % | 44.0 | 46.0 |
| D7121 | | | | |
| ASTM | Shore A Hardness | points | 64 | 66 |
| D2240 | | | | |
| ASTM | Tensile Strength | psi | 944.0 | 1297.0 |
| 412 | M100 | psi | 179.0 | 282.0 |
| | M300 | psi | 451.0 | 1073.0 |
| | Elongation | % | 350.0 | 778.0 |
| ASTM | Tear Strength | pli | 176.0 | 218.0 |
| D624 | | | | |
| ASTM | Stitch Tear | lbf | 26 | 30 |
| D4705 | Strength | | | |
| ASTM | Abrasion | | | |
| D5963 | Resistance | | | |
| | Abrasion Loss | mm³ | 175.0 | 221.0 |
| | ARI | % | 67 | 84 |
| ASTM | Specific Gravity | 23/23 | 1.1400 | 1.1600 |
| D792 | Density | g/cc | 1.1400 | 1.1500 |
| ASTM | Compression Set | % | 38 | 69 |
| D395 | | | | |
| ASTM | Ross Flex | | | |
| D1052 | Cut Growth | cycles | 100,000 | 153,846 |
| | (100%) | | | |
| | Cut Growth | cycles | 75,000 | 115,385 |
| | (50%) | | | |

### Example 9

Several vulcanized rubber final products (e.g., shoe soles) were made using various embodiments of the devulcanized recycled precursor material of the present invention. The processes for making these products and the characteristics of the final products are described in this Example.

In a first aspect, 25% of the devulcanized recycled precursor material of the present invention was used in combination with 75% virgin rubber for compounding a shoe sole. The virgin rubber was mixed with the devulcanized rubber and chemical additives were added (but not curative agents and sulfur). Carbon black and processing oil were added next to the masterbatch. Finally curative agents and sulfur were added to this master batch to form a cured, vulcanized rubber for molding into the proper shape.

Several different devulcanized recycled precursor materials were used in preparing the final vulcanized rubber product and it was found that those samples that had been treated with a turpentine liquid at temperatures of about 90° C. up to about 160° C. for about 20 to about 60 minutes, then treated with alcohol to remove the turpentine liquid produced precursor devulcanized materials having suitable characteristics similar to virgin rubber and could be used to predictably and economically produce high quality vulcanized rubber products. The vulcanized rubber based footwear final products formed according to these experiments were found to have the following characteristics:

TABLE 10

| Characteristic | Value |
|---|---|
| Shore A Hardness (SATRA TM205) | 59-61 |
| Specific Gravity (g/cm³) (SATRA TM134) | 1.14-1.15 |
| Tensile Strength (kg/cm²) (ASTM D412) | 133-148 |
| Elongation % (ASTM D412) | 390-476 |
| Die T Tear Strength (kg/cm Thickness) (SATRA TM218) | 11.8-18.9 |
| DIN Abrasion Resistance (mm³) (SATRA TM174) | 126-162 |
| Oil Resistance (%) (Trimethylpentane) (SATRA TM63) | 1.2-2.7 |
| Oil Resistance (%) (IRM #903) (FIA-319 - IRM #903) | 0.6-4.2 |
| Modulus at 100% (kg/cm²) | 79-102 |
| Modulus at 300% (kg/cm²) | 17-20 |

The devulcanized recycled precursor material of the present invention was used at increasing content amounts in combination with correspondingly decreasing amounts of virgin rubber for compounding a shoe sole. The vulcanized rubber based footwear final products formed according to these experiments were found to have the following characteristics:

TABLE 11

| | 25% | 30% | 35% | 40% | 45% | 50% |
|---|---|---|---|---|---|---|
| | Precursor | Precursor | Precursor | Precursor | Precursor | Precursor |
| | Material/ | Material/ | Material/ | Material/ | Material/ | Material/ |
| | 75% virgin | 70% virgin | 65% virgin | 60% virgin | 55% virgin | 50% virgin |
| Characteristic | rubber | rubber | rubber | rubber | rubber | rubber |
| Shore A Hardness | 60 | 59 | 58 | 57 | 57 | 56 |
| (SATRA TM205) | | | | | | |
| Specific Gravity | 1.15 | 1.15 | 1.15 | 1.15 | 1.15 | 1.15 |
| (g/cm³) (SATRA | | | | | | |
| TM134) | | | | | | |
| Tensile Strength | 133.0 | 124.0 | 123.0 | 113.0 | 109.0 | 88.0 |
| (kg/cm²) (ASTM | | | | | | |
| D412) | | | | | | |
| Elongation % (ASTM | 443 | 422 | 430 | 415 | 402 | 396 |
| D412) | | | | | | |
| Die T Tear Strength | 13.4 | 14.3 | 15.4 | 15.7 | 16.3 | 15.0 |
| (kg/cm Thickness) | | | | | | |
| (SATRA TM218) | | | | | | |
| DIN Abrasion | 162 | 167 | 173 | 177 | 179 | 196 |
| Resistance (mm³) | | | | | | |
| (SATRA TM174) | | | | | | |
| Oil Resistance (%) | 2.41 | 3.47 | 4.90 | 5.73 | 10.64 | 16.68 |
| (Trimethylpentane) | | | | | | |
| (SATRA TM63) | | | | | | |
| Oil Resistance (%) | 1.23 | 1.48 | 1.83 | 2.43 | 3.28 | 3.92 |
| (IRM #903) (FIA-319 - | | | | | | |
| IRM #903) | | | | | | |
| Modulus at 100% | 83 | 82 | 79 | 76 | 76 | 63 |
| (kg/cm²) | | | | | | |
| Modulus at 300% | 19 | 19 | 18 | 18 | 18 | 17 |
| (kg/cm²) | | | | | | |

### Example 10

In this example, properties of vulcanized rubber samples treated with a turpentine liquid blend of terpineol, pinene and cymene to obtain a precursor material using short contact times are described.

TABLE 12

| | | | Modulus | Modulus at |
|---|---|---|---|---|
| Time | Tensile Strength | Elongation at | at 50% | 50% Range |
| (min) | Range (MPa) | Break Range (%) | Range (MPa) | (MPa) |
| 0.08 | 2-3 | 95-120 | 1-2 | 2-3 |
| 1 | 2-3 | 90-120 | 1-2 | 2-3 |
| 5 | 1.5-3 | 70-110 | 1-2 | 2-3 |

### Example 11

Exemplary formulations that are used to obtain a precursor material include, but are not limited to the following:
One of the following: 100% alpha-terpineol; 100% alpha-pinene; 100% beta-pinene; 100% para-cymene; or 100% pine oil;
30-70% α-terpineol, 5-40% β-pinene, 5-50% α-pinene, and 0-30% p-cymene;
40-60% α-terpineol, 10-20% α-pinene, 10-40% β-pinene, and 5-20% p-cymene;
45-55% α-terpineol, 30-40% α-pinene, 5-30% β-pinene, and 10-30% p-cymene;
50% α-terpineol, 25% α-pinene, 20% β-pinene, and 5% p-cymene;
30-70% pine oil, 30-70% α-terpineol, 5-40% β-pinene, 5-50% α-pinene, and 0-30% p-cymene;
30-50% pine oil, 40-60% α-terpineol, 10-20% α-pinene, 10-40% β-pinene, and 5-20% p-cymene;
30-40% pine oil, 45-55% α-terpineol, 30-40% α-pinene, 5-30% β-pinene, and 10-30% p-cymene.

### Example 12

The precursor material, i.e., devulcanized rubber, obtained using the formulations of Example 11 was used to make a vulcanized rubber product having surprisingly high quality and advantageous properties for use as a vulcanized recycled rubber product in a variety of commercial applications. Vulcanized rubber products having surprisingly high quality and advantageous properties were made using the following formulation ranges:

TABLE 13

| | PHR |
|---|---|
| Ingredient | Range |
| Virgin Rubber | 100 |
| APX ™ | 150-250 |
| Carbon Black | 5-65 |
| Dioctyl Terephthalate (DOTP) | 10-40 |
| Zinc Oxide | 2-8 |
| Stearic Acid | 0.5-4 |
| Octylated Diphenylamine (ODP) | 0-3 |
| Coumarone Indene Resin | 0-25 |
| Benzothiazole Disulfide (MBTS) | 0-3 |
| Benzothiazole-2-thiol (MBT) | 0-2 |
| Tetramethylthiuram Disulfide (TMTD) | 0-2 |
| Sulfur | 1-5 |
| | 268.5-507 |

Advantageous properties of an exemplary vulcanized rubber product produced by the inventive formulation are summarized in Table 14.

TABLE 14

| | Test | Typical Target | Specifications for |
|---|---|---|---|
| Tests Performed | Method | Specifications | Inventive Product |
| Shore A Hardness | SATRA | 60-65 | 60 |
| | TM205 | | |
| Specific Gravity (g/cm³) | SATRA | below 1.2 | 1.15 |
| | TM134 | | |
| Tensile Strength | ASTM | >100 kg/cm² | 133.0 |
| (kg/cm²) | D412 | | |
| Elongation (%) | ASTM | >400% | 443 |
| | D412 | | |
| Die T Tear Strength | SATRA | >8 kg/cm | 13.4 |
| (kg/cm Thickness) | TM218 | | |
| DIN Abrasion Resistance | SATRA | <150 mm³ | 162 |
| (mm³) | TM174 | | |
| Oil Resistance (%) | SATRA | <12% | 2.41% |
| (Trimethylpentane) | TM63 | | |
| Oil Resistance (%) (IRM | FIA-319- | <10% | 1.23% |
| #903) | IRM #903 | | |

As demonstrated by the exemplary data, the inventive product is capable of satisfying the stringent target specifications necessary for making a commercially successful vulcanized rubber product.

It was found that the devulcanized recycled precursor material of the present invention was useful even when used in large proportions for predictably and economically producing high quality vulcanized rubber products.

In summary, vulcanized rubber products containing precursor material according to the present invention have higher elongation (can be stretched longer until it breaks) and higher tensile strength when compared to vulcanized rubber products containing crumb rubber that is not processed according to the present invention. Also, devulcanized rubber precursor material according to the present invention has higher elongation and higher tensile strength when compared to the comparative material (unprocessed crumb rubber). The higher elongation and tensile strength indicates a higher degree of devulcanization of the rubber in the precursor material.

As used herein, the terms about and approximately should be interpreted to include any values which are within 5% of the recited value. Furthermore, recitation of the term about and approximately with respect to a range of values should be interpreted to include both the upper and lower end of the recited range. As used herein, the terms first, second, third and the like should be interpreted to uniquely identify elements and do not imply or restrict to any particular sequencing of elements or steps.

While the invention has been shown or described in only some of its embodiments, it should be apparent to those skilled in the art that it is not so limited, but is susceptible to various changes without departing from the spirit and scope of the invention. Furthermore, it is to be understood that the form of the invention shown and described is to be taken as presently preferred embodiments. Various modifications and changes may be made to each and every processing step as would be obvious to a person skilled in the art having the benefit of this disclosure. It is intended that the following claims be interpreted to embrace all such modifications and changes and, accordingly, the specification is to be regarded in an illustrative rather than a restrictive sense. Moreover, it is intended that the appended claims be construed to include alternative embodiments.

1. A precursor material for making a final vulcanized recycled rubber product, said precursor material comprising devulcanized, recycled rubber, and having a plurality of parameters selected from the group consisting of a tensile strength of about 1-10 MPa, elongation at break of about 60-300%, a 50% modulus of about 0.5 to 5 MPa, a 100% modulus of about 1-7 MPa, and Shore A hardness of about 40-80.

2. The precursor material of claim 1, wherein said devulcanized, recycled rubber is a sulfur-based rubber.

3. The precursor material of claim 1, wherein said devulcanized, recycled rubber has a particle size within the range of about 325 mesh to about 1 mesh.

4. The precursor material of claim 1, comprising less than 2% moisture content according to ASTM D1509.

5. The precursor material of claim 1, comprising less than about 1% metal content according to ASTM D5603.

6. The precursor material of claim 1, comprising less than about 0.5% fiber content according to ASTM D5603.

7. The precursor material of claim 1, comprising about 2-10% acetone extractables according to ASTM E1131-03 (TGA).

8. The precursor material of claim 1, comprising about 2-5% acetone extractables according to ASTM E1131-03 (TGA).

9. The precursor material of claim 1, comprising about 30-65% polymer rubber hydrocarbon (RHC) content according to ASTM E1131-03 (TGA).

10. The precursor material of claim 1, comprising about 20-50% carbon black and/or silica content according to ASTM E1131-03 (TGA).

11. The precursor material of claim 1, comprising about 20-45% organic ash content according to ASTM E1131-03 (TGA).

12. The precursor material of claim 1, having a specific gravity of about 1.05-1.3 according to ASTM D1817.

13. The precursor material of claim 1, having a bulk density of about 0.20 to about 0.33 kg/liter.

14. The precursor material of claim 1, having a bulk density of about 0.24 to about 0.32 kg/liter.

15. The precursor material of claim 1, having a bulk density of about 0.25 to about 0.31 kg/liter.

16. The precursor material of claim 1, comprising a plasticizer selected from the group consisting of hydrocarbon oil, naphthenic oil, and lubrication oil.

17. The precursor material of claim 1, having a polymer portion comprising natural rubber, polybutadiene rubber, nitrile and styrene-butadiene rubber.

18. The precursor material of claim 1, having a polymer portion comprising about 20% natural rubber and about 80% styrene-butadiene rubber.

19. The precursor material of claim 1, having a polymer portion comprising about 90% natural rubber and about 10% styrene-butadiene rubber.

20. The precursor material of claim 1, having a polymer portion comprising about 80% natural rubber and about 20% polybutadiene rubber.

21. The precursor material of claim 1, having a polymer portion comprising about 80% nitrile rubber, 10% natural rubber and about 10% polybutadiene rubber.

22. The precursor material of claim 1, having a polymer portion comprising about 20% nitrile rubber, 10% natural rubber and about 70% polybutadiene rubber.

23. The precursor material of claim 1, wherein said precursor material has at least three of said parameters.

24. The precursor material of claim 1, wherein said precursor material has at least four of said parameters.

25. The precursor material of claim 1, wherein said precursor material has all of said parameters.

26. A vulcanized recycled rubber product comprising the precursor material of claim 1 as a majority portion.

27. A vulcanized recycled rubber product having a plurality of parameters selected from the group consisting of a tensile strength of about 80-150 kg/cm², a specific gravity of 1.10-1.25 g/cm³ according to SATRA TM205, Die T Tear strength of 13-20 kg/cm thickness according to SATRA TM218, DIN abrasion resistance of 120-200 mm³ according to SATRA TM174, oil resistance (trimethylpentane) of 1-20% according to SATRA TM63, oil resistance of about 0.5-5% according to FIA391 IRM #903, a 100% modulus of about 60-100 kg/cm², and a 300% modulus of about 15-25%; and before vulcanization of said vulcanized recycled rubber product, about 10%-80% by weight devulcanized, recycled rubber.

28. The vulcanized recycled rubber product of claim 27, comprising a plasticizer selected from the group consisting of hydrocarbon oil, naphthenic oil, and lubrication oil.

29. The vulcanized recycled rubber product of claim 27, wherein said vulcanized recycled rubber product has at least three of said parameters.

30. The vulcanized recycled rubber product of claim 27, wherein said vulcanized recycled rubber product has at least four of said parameters.

31. The vulcanized recycled rubber product of claim 27, wherein said vulcanized recycled rubber product has all of said parameters.

32. A vulcanized recycled rubber product comprising a polymer portion comprising a vulcanized mixture of 20 to 90% by weight virgin rubber and 10 to 80% by weight of a precursor material having, before vulcanization, a plurality of parameters selected from the group consisting of a tensile strength of about 1.8-6.7 MPa, elongation at break of about 80-140%, a 50% modulus of about 1.3 to 3 MPa, a 100% modulus of about 2.0-4.5 MPa, and Shore A hardness of about 50-65.

33. The vulcanized recycled rubber product of claim 32, having shore A hardness of at least about 56, tensile strength of about 88-148 kg/cm² and elongation of about 430-480%.

34. The vulcanized recycled rubber product of claim 32, having a plurality of parameters selected from the group consisting of a specific gravity of 1.10-1.25 g/cm³ according to SATRA TM205, Die T Tear strength of 13-20 kg/cm thickness according to SATRA TM218, DIN abrasion resistance of 120-200 mm³ according to SATRA TM174, oil resistance (trimethylpentane) of 1-20% according to SATRA TM63, oil resistance of about 0.5-5% according to FIA391 IRM #903, a 100% modulus of about 60-100 kg/cm², and a 300% modulus of about 15-25%.

35. The vulcanized recycled rubber product of claim 32, wherein precursor material has at least three of said parameters.

36. The vulcanized recycled rubber product of claim 32, wherein said precursor material has at least four of said parameters.

37. The vulcanized recycled rubber product of claim 32, wherein said precursor material has all of said parameters.

38. A method for making a devulcanized rubber material having a plurality of parameters selected from the group consisting of a tensile strength of about 1.8-6.7 MPa, elongation at break of about 80-140%, a 50% modulus of about 1.3 to 3 MPa, a 100% modulus of about 2.0-4.5 MPa, Shore A hardness of 50-65, comprising contacting a vulcanized rubber having a sulfur content and sulfur cross-links with a devulcanizing agent in a reaction mixture at about 80° C. to about 170° C. for about 10 to about 100 minutes, the devulcanizing agent being a turpentine liquid to form a processed devulcanized rubber, treating said processed devulcanized rubber with an alcohol, or a mixture of the alcohol with an organic compound with one or more hydroxyl functional group(s) and/or an organic or inorganic solvent, to remove the turpentine liquid from said processed devulcanized rubber, thereby forming said devulcanized rubber material.

39. The method of claim 38, wherein said contacting occurs at a temperature of about 85° C. to about 165° C. for about 20 to about 80 minutes.

40. The method of claim 39, wherein said contacting occurs at a temperature of about 90° C. to about 160° C. for about 20 to about 60 minutes.

41. The method of claim 38, wherein said reaction mixture comprises said turpentine liquid and said vulcanized rubber in a ratio of about 2:1 to about 7:1.

42. The method of claim 41, wherein said reaction mixture comprises said turpentine liquid and said vulcanized rubber in a ratio of about 3:1 to about 5:1.

43. The method of claim 38, wherein said devulcanized rubber material has at least three of said parameters.

44. The method of claim 38, wherein said devulcanized rubber material has at least four of said parameters.

45. The method of claim 38, wherein said devulcanized rubber material has all of said parameters.

46. A method for making a final vulcanized recycled rubber product, comprising obtaining a precursor material comprising about 10%-80% by weight of a devulcanized, recycled rubber, and having a plurality of parameters selected from the group consisting of a tensile strength of about 1.8-6.7 MPa, elongation at break of about 80-140%, a 50% modulus of about 1.3 to 3 MPa, a 100% modulus of about 2.0-4.5 MPa, Shore A hardness of 50-65, comprising compounding said precursor material with virgin rubber to form a mixture, and vulcanizing said mixture to obtain said final vulcanized recycled rubber product.

47. The method of claim 46, wherein said method is adapted so as to obtain said final vulcanized recycled rubber product having a tensile strength of about 80-150 kg/cm².

48. The method of claim 46, wherein said method is adapted so as to obtain said final vulcanized recycled rubber product having a specific gravity of 1.10-1.25 g/cm³ according to SATRA TM205.

49. The method of claim 46, wherein said method is adapted so as to obtain said final vulcanized recycled rubber product having Die T Tear strength of 13-20 kg/cm thickness according to SATRA TM218.

50. The method of claim 46, wherein said method is adapted so as to obtain said final vulcanized recycled rubber product having DIN abrasion resistance of 120-200 mm³ according to SATRA TM174.

51. The method of claim 46, wherein said method is adapted so as to obtain said final vulcanized recycled rubber product having oil resistance (trimethylpentane) of 1-20% according to SATRA TM63.

52. The method of claim 46, wherein said method is adapted so as to obtain said final vulcanized recycled rubber product having oil resistance of about 0.5-5% according to FIA391 IRM #903.

53. The method of claim 46, wherein said method is adapted so as to obtain said final vulcanized recycled rubber product having a 100% modulus of about 60-100 kg/cm².

54. The method of claim 46, wherein said method is adapted so as to obtain said final vulcanized recycled rubber product having a 300% modulus of about 15-25%.

55. The method of claim 46, wherein said final vulcanized recycled rubber product has at least three of said parameters.

56. The method of claim 46, wherein said final vulcanized recycled rubber product has at least four of said parameters.

57. The method of claim 46, wherein said final vulcanized recycled rubber product has all of said parameters.

58. A vulcanized recycled rubber product formulation comprising virgin rubber, carbon black, zinc oxide, stearic acid, sulfur, and a precursor material comprising devulcanized, recycled rubber, and wherein said vulcanized recycled rubber product does not contain silica.

59. The vulcanized recycled rubber of claim 58, further comprising a plurality of Dioctyl Terephthalate (DOTP), Octylated Diphenylamine (ODP), Coumarone Indene Resin, Benzothiazole Disulfide (MBTS), Benzothiazole-2-thiol (MBT), and Tetramethylthiuram Disulfide (TMTD).

60. The vulcanized recycled rubber of claim 58, having Shore A hardness of 60-65, specific gravity below 1.2 g/cm³, tensile strength >100 kg/cm², elongation strength >400%, die T tear strength >8 kg/cm, DIN abrasion resistance <150 mm³, oil resistance (trimethylpentane) <12%, and oil resistance (IRM #903) <10%.
